(19) United States
(12) Patent Application Publication
(10) Pub. No.: US 2005/0244681 A1
(43) Pub. Date: Nov. 3, 2005

(54) Method and system for controlling fluid flow in a fuel processing system

(76) Inventors: Gregory D. Len, Boston, MA (US); Fortunat J. Mueller, West Hartford, CT (US); Vincent Rizzo, Norfolk, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/533,368

(22) PCT Filed: Oct. 30, 2003
(86) PCT No.: PCT/US03/34541

§ 371 Date: Jul. 18, 2005

Related U.S. Application Data
(60) Provisional application No. 60/422,616, filed on Oct. 30, 2002.

(51) Int. Cl. H01M 8/06; C01B 3/32; B01J 8/04

(52) U.S. Cl. 429/17; 429/19; 422/190; 48/61

(57) ABSTRACT

Fuel processing systems, which reform a hydrocarbon fuel to produce hydrogen suitable for use in a fuel cell, have multiple air inlets for various process steps. Controls and feedback loops are correspondingly complex. Controlling the multiple airflows to a pressurized fuel processor using a single onboard compressor and a number of low pressure drop valves is a significant challenge to overcome in the process of getting a reformed on board a vehicle. A method has been developed for controlling the compressor speed based on the airflow demand of the partial oxidation (POX) zone, without direct feedback from the other airflows in the system. This ensures that the principal zone of air consumption always gets the appropriate amount of air, thus controlling the temperature of that zone and the reaction chemistry effectively. This method also allows removal of extra flow sensors from airflows where the effect of changed airflow (e.g. temperature change) can be used as a feedback to an air controller instead of the actual airflow itself. Similar principles are applicable in the control of other flows, such as fuel and water, when several flows are fed by a common source.

### RELATED APPLICATION(S)

This application claims the benefit of U.S. Provisional Application No. 60/422,616, filed Oct. 30, 2002, the entire teachings of which are incorporated herein by reference.

### BACKGROUND OF THE INVENTION

Fuel reformers and integrated fuel processors are well known for production of hydrogen. Historically, such fuel processors have been used in large chemical plants, producing hydrogen for chemical synthesis. There is increasing interest in using such reactors for small scale and/or mobile applications. In such uses, it is important to simplify the control system as much as possible, to minimize both cost and complexity, and to improve maintainability in a “consumer” environment.

In general, fuel reformers receive input flows of three fluids (i.e. fuel, air, and water), which undergo various reactions in the reformer to produce an output flow of hydrogen. In a first stage, for example, the fuel reformer catalyzes the reaction of a fuel with water to form hydrogen and carbon monoxide. This first step in the reaction is endothermic, and requires heat to be supplied to the catalytic reaction. This step is generally referred to as partial oxidation (POX) of the fuel, and is typically done by burning part of the fuel in the catalytic bed, either by combustion or by catalytic reaction. The catalytic version of the POX reaction is often referred to as autothermal reforming (ATR).

As an alternative to the POX reaction, fuel and water can be reacted in a catalyst bed that is heated by a separate burner, which uses air and additional fuel to create heat. This is known as “pure” steam reforming.

With both POX and “pure” steam reforming reactions, after the fuel and water have undergone the initial catalytic reaction to produce hydrogen and carbon monoxide, subsequent steps are utilized to convert carbon monoxide and water (as steam) into hydrogen and carbon dioxide. These steps typically include the “water gas shift” (WGS) reaction, which reacts carbon monoxide with water to produce carbon dioxide and hydrogen. As a final step, a preferential oxidation (PrOx) process is used to remove residual carbon monoxide using small amounts of air and a catalyst.

In an integrated fuel reformer/fuel cell system, the output hydrogen from the reformer is fed to a fuel cell, where it reacts with oxygen or air to produce electricity. The leftover hydrogen from the fuel cell is normally burned with more air, and in some cases with additional fuel, to produce heat for the first fuel reforming reaction, or for preheating fuel, air or steam. A fuel processor includes all of these reactions, including the use of leftover fuel cell gases.

Typically, each of the three primary inputs into the fuel processor (i.e. fuel, air, and water) is fed to more than one point of use. Using air flow for an example, typically at least three separate inputs of air are required. These include air used to make heat for the reforming reaction; air for the PrOx reaction; air for the fuel cell; and air for the terminal burner when present. In some cases, the leftover air flow from the fuel cell is sufficient to also support heat creation for the reforming process. Other configurations may require four or more air flows. Of these air inputs, the air flow for the fuel cell is often the largest volume flow. However, the flow rate for the burner or ATR or POX reaction is often the most critical, because there must be a precise amount of air provided to efficiently reform the fuel while maintaining temperatures in safe limits.

In a small or mobile system, it is strongly preferred that only one air compressor be used. (And in the case of water and fuel flow, that only one water or fuel pump be used.) For automatic control of the system, a “model” must be implemented on a system controller. An important method of controller model design is performed by frequency-response analysis. The Nyquist stability criterion enables the investigation of both the absolute and relative stabilities of linear closed-loop systems from the knowledge of their open-loop frequency response characteristics. Simplified system models are often employed to represent the control system plant. An input-output model is a basic concept of a dynamic system interacting with its surroundings via input variables and output variables. An example of a single input, single output system could be a pump-flow meter system. The input would be the pump command signal, and the output would be the flow.

In the previously described system, the fuel processor has an air delivery system with multiple airflows coupled to one source, the onboard compressor. The modeling of the air system therefore becomes a dynamic system with multiple-inputs and multiple outputs. The input-output equations, even for relatively simple multi-input, multi-output models become extremely complicated. The conceptual simplicity of using the input-output representation of a dynamic system is lost in the complexity of the mathematical forms with models that are nonlinear, have many inputs and/or outputs, or simply are of an order higher than 3.

Accordingly, a control system for three or four coupled flows (for example, the air inlet from the compressor and three independent outlets) is surprisingly complex to implement, and prone to instability. It therefore typically requires direct measurement of each flow, which is itself expensive. Similar considerations may also apply to water and fuel flows, depending on the details of system design. It would be desirable to simplify the control of multiple flows of air, and of water and fuel, in a fuel processor, both to minimize cost and to improve system stability.

### SUMMARY OF THE INVENTION

This invention relates to simplified and improved methods for the control of gas and liquid flows in a fuel processor which comprises a fuel reformer, one or more hydrogen cleanup modules, and fluid flows to and from a fuel cell. In one embodiment, a method for simplifying the control of flow of a fluid in a fuel processor comprises determining, from among a number of possible inputs for the fluid in the fuel processor, a first fluid input which requires the greatest precision of control of the rate of fluid flow. The rate of fluid flow at this first input is regulated based upon feedback from a sensor associated with the first fluid input, wherein such regulation occurs with a first time constant. The rate of fluid flow at each of the remaining inputs is regulated based upon feedback from at least one sensor so that the flows have a regulatory time constant that is at least about three fold longer than the time constant of regulation of the first flow and/or have a flow volume that is less than about 10% of the average flow volume of the fluid at the first input. In the case of air flow, for instance, the fluid input which requires the greatest degree of control is generally input to the POX unit of the fuel processor (or equivalently to the ATR unit, or to the burner supplying steam in the case of a steam reforming unit), in other words, air flow to the combustion that supplies heat for the fuel reforming reaction.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of the flows of air and reformate in a fuel processor and associated fuel cell; and

FIG. 2 is an outline of the control flows in the system processor.

### DETAILED DESCRIPTION OF THE INVENTION

A description of preferred embodiments of the invention follows.

In this application, “fluid flow” refers to flows of any fluid in a fuel processor, including particularly air, water (as liquid and/or as steam) and fuel. “Fluid flow” also includes the flow of leftover hydrogen from the fuel cell, which is often recycled and used as an ancillary fuel in the reformer. A “fuel processor” refers to a system comprising a fuel reformer, its associated hydrogen cleanup apparatus (usually WGS reaction and PrOx reaction), its ancillary equipment (compressors and the like), and its connections with a fuel cell via flows of air, water, and hydrogen. A partial oxidation reformer (POX) includes the catalytic version commonly called an ATR (autothermal reformer) unless otherwise stated. A “time constant” is the characteristic time for a response to be completed to a defined extent, such as ½ or 1/e. A longer time constant produces a slower response. A response time may alternatively be represented as the inverse of the time constant, (i.e. a “bandwidth”), where a larger value of bandwidth corresponds to a smaller time constant and to a faster response.

We have found that the control systems for fluid flows in a fuel processor can be greatly simplified by regulating the various flows with valves or other controllers having different response times. To minimize complexity, the control methodology of the air system (or equivalently, the fuel or water system) is developed so that each flow into the system is modeled and designed as an independent single input-output system. The logic diagrams for this controller are thus extremely simple.

In the case of air flow, for instance, the fluid input which requires the, greatest degree of control, typically the flow to the POX (or equivalently to the ATR unit), i.e. to the combustion that supplies heat for the reforming reaction, is regulated with a short time constant (large bandwidth), and typically via direct feedback from a sensor, such as an air flow sensor. Other types of sensors could be used, such as a temperature or pressure sensor, as an alterative to, or in combination with, the air flow sensor. The feedback from the sensor is used by the system controller to regulate the compressor. In one embodiment, this is performed by having a variable rate compressor. Other types of compressors can be used, including compressors with variable pitch of vanes, single-speed compressors with variable duty cycles, and other known types of compressors. Any form of compressor that can supply the fuel processor can be regulated as described herein. The total flow of the compressor is regulated by the controller using feedback from the POX sensor or sensors. Then, to decouple the flows and simplify the control system, the other air flows are controlled by controllers having substantially longer time constants for response. For example, the response times of the other air flow controllers will typically be at least about three times as long as the response time of the POX air controller, and preferably at least four times as long, and more preferably at least five times to ten times (or more) as long. Larger ratios of time constants (greater than about 10 times) will not significantly improve decoupling, but could be implemented if required for other purposes. As will be described in more detail below, the effect of adjustment of less-critical flows is seen by the controller as a variation in the more rapidly-controlled POX airflow. The rapid response of the POX flow control allows regulation of the other flows to be decoupled from the POX flow, thereby greatly simplifying the control algorithms.

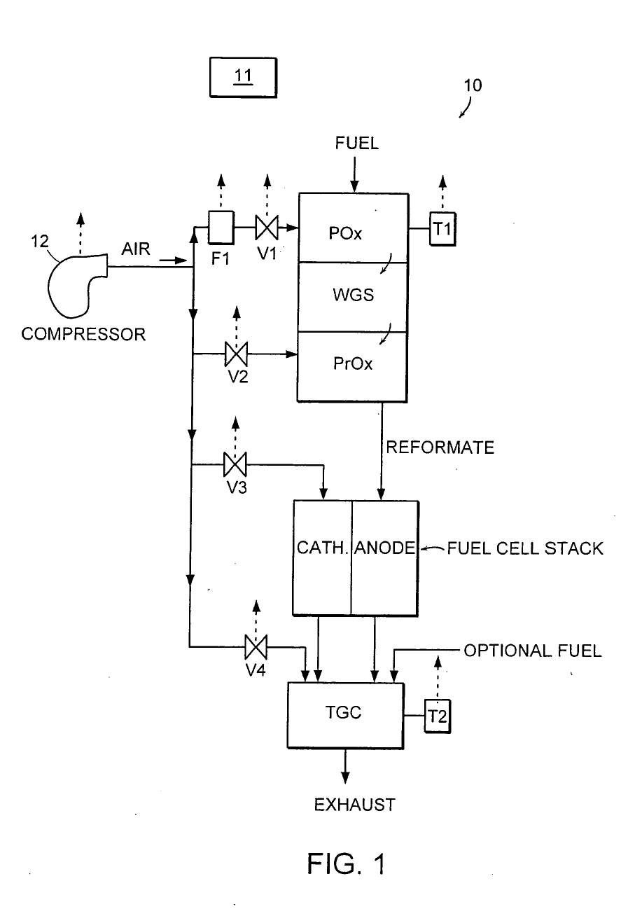

FIG. 1 shows a schematic of a typical POX-type reformer system 10. In FIG. 1, dotted lines represent air-flow related control lines to a system controller 11. (Note that although a single system controller 11 is shown here controlling all inputs of a particular fluid to the system, each fluid input into the system can have an associated controller for receiving input data from the system—such as flow rates, temperatures, fuel input rates, etc.—and using this data to control the particular flow rate, such as by adjusting a valve or varying compressor speed.) Also shown in FIG. 1 is compressor 12, which in this example is a variable-rate compressor. Air from the compressor is fed to a plenum, and from the plenum to fuel processor components via illustrated controllable valves (V1, V2, V3, V4). Valve V1 feeds the initial fuel reforming unit, labeled POX. The POX unit has a flow sensor F1 associated with air flow into V1. It may also or instead have an associated temperature sensor T, or another sort of measuring device, depending on details of system design. The air flow rate, or other control parameter, is communicated to the controller 11, which adjusts the speed of the compressor 11 to maintain the air flow and/or temperature of the POX unit within a selected range. (Note that in this particular embodiment, the valve V1 is entirely open in a normal operating state, and is shut only in other system states.) The air flow controlling signal is filtered and processed to eliminate noise, and will have a characteristic response rate R1, which may be expressed in terms of bandwidth at the controller. (Note that a slower response corresponds to a smaller bandwidth, i.e., fewer possible cycles of adjustment per second.) Alternatively, the feedback from the POX may be via a temperature sensor T, or via a measurement of the influx rate of fuel, since the required air flow rate is a proportion of the fuel input rate. The proportion may vary depending on the system state—for example, startup vs. steady state—and the controller can be programmed to adjust the proportion depending on the overall state of the system. In such a system, the valve V1 is typically simply on or off, or, in some embodiments, the valve V1 may not be present in the system; in such cases, flow rate is directly regulated via compressor speed. The response rate R1 then refers to the response time of the sampling of the air flow, temperature, or other parameter, as used to regulate the volume output of the compressor, for example by varying its speed.

Another control method having similar decoupling characteristics allows valve V1 to be a proportioning valve, of any convenient sort. In this case, a constant pressure is maintained in the plenum, and the POX air flow rate is controlled by the fraction of time that V1 is open, or the degree to which V1 is open. The key sensed value could then be the plenum pressure, which could be sensed and controlled by adjusting the compressor speed, or its volumetric output per unit time, or, with a fixed speed compressor, its duty cycle. In each case, the input into the controller for controlling valve V1 will have a characteristic response rate or bandwidth, R1.

Valve V2 controls air flow into the PrOx (Preferential Oxidation reactor), which is part of the hydrogen cleanup system. As illustrated, the reformate leaves the POX unit and passes through the WGS (water gas shift) unit, where carbon monoxide is reacted with water to produce additional hydrogen. The reformate then enters the PrOx unit to remove residual carbon monoxide. The PrOx unit catalytically reacts residual carbon monoxide with added air, to prevent fuel cell poisoning. For efficiency, air usage in the PrOx unit should be minimized. The amount of air needed to remove residual carbon monoxide with the PrOx can be determined in any of several ways. For example, it can be calculated by the controller based on the rate of fuel input, as adjusted for the system state. Alternative inputs to the controller include PrOx temperature, and values from a carbon monoxide sensor.

As with the controls for V1, the inputs supplying data for controlling V2, or the control systems acting on the data, will also have a characteristic response rate, R2. The PrOx is illustrated here as having one air inlet, but in practice there may be several air inlets to a PrOx. These are not illustrated; they may be controlled by further valves from a plenum, either the one illustrated or a separate plenum downstream of V2; or may be proportioning orifices in a second plenum, or otherwise arranged.

Valve V3 controls air flow into the fuel cell. In the arrangement illustrated, the fuel cell air is then used as the sole or primary air source for an auxiliary burner or “tail gas combustor” (TGC). However, the TGC could instead or in addition have a separately regulated air supply (V4). Air flow through fuel cell inlet valve V3 can be regulated according to one or more of several variables, including fuel input rate, electricity production rate or demand rate, or other measurable or calculable parameters. The input into the controller for controlling valve V3 will have a characteristic response rate or bandwidth R3, and V4, if present, a bandwidth or time constant R4.

The design shown in FIG. 1 is close to the minimal number of required air inlets into the integrated system (noting that V4 is optional in some systems). Any additional air flow control valves V5, etc. that may be present due to details of system design will likewise have response rates R5, etc.

In the system illustrated in FIG. 1, the rate of air flow to the reforming element of the system, here labeled as POX, is the flow rate requiring the most precise degree of control, relative to the rate of air flow to the other system components. This is because the reformer must be operated at a high temperature (typically in the range of 700 deg. C. or above; lower with methanol fuel), and the operating temperature must be controlled to be within a relatively narrow range—high enough to provide heat for the reforming reaction at a rate sufficient to reform the non-oxidized fuel, but low enough not to damage system components, including the catalysts and structural elements. Moreover, combustion of fuel in excess of that required to reform the rest of the fuel is wasteful and reduces system efficiency.

The other air flows, in this particular embodiment, are less critical, and do not need to be regulated as tightly. The PrOx supply is relatively low in volume compared to the reformer heating air flow, and so a less tight regulation may be acceptable. Moreover, the volume of the PrOx flow is less than 10% of the reformate flow, and more typically less than 3% of the POX flow. Therefore, regulation of the PrOx flow at any response rate will not significantly perturb the system pressure or the flow rate into the POX.

The third flow is the air supplied to the fuel cell and/or the TGC, regulated by V3 and/or V4. These flows are large in volume, but the exact amount is not as critical as the flow of POX air in terms of regulation, since air is normally supplied in excess to both the fuel cell cathode and the TGC or equivalent. The associated response time constants are R3 and R4.

These considerations allow a great simplification of the control algorithm. The response rate R1 of the POX control is selected to be the fastest response rate in the air control system. The other response rates R2, R3, etc., are selected to be slower than the response rate R1. This typically requires that the response rates R2, R3 of the other components be at least about a factor of about three or four times slower than the rate for the POX, or more preferably a factor of at least about.,5 times, or at least about 10 times slower. (As noted above, values above 10 are possible in the invention, but are larger than is required for stability and decoupling.)

However, when another flow is small enough to not perturb the pressure in the manifold, or equivalent structure, then the regulation of the flow in that component may be at any response rate. For example, as noted, this criterion will often be applicable to the PrOx flow.

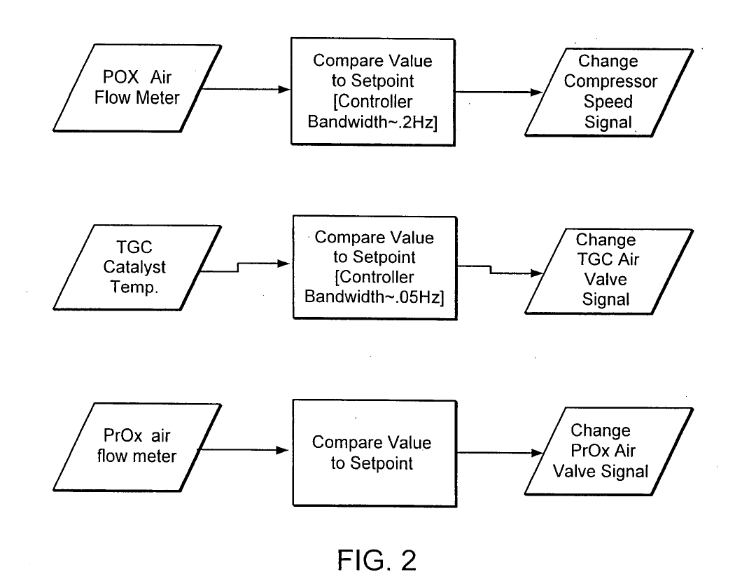

An example of the logic flow of such regulation is shown in FIG. 2 (with reference to the system components of FIG. 1). The POX flow, in this case regulated by a flow meter (F1), is measured in the POX controller and compared to a set point with a relatively rapid response time (0.2 Hz bandwidth). Based upon the measured flow rate, the POX controller directly controls the compressor 12 to provide the desired POX flow rate.

The TGC/fuel cell flow, which is sufficiently large so that variations in its flow rate will significantly perturb overall system pressure, is regulated via fuel cell demand and/or TGC temperature with a slower controller response, here 0.05 Hz bandwidth. Here, the TGC/fuel cell controller does not directly control the compressor, but instead only regulates the inlet valve or valves associated with the TGC/fuel cell components (i.e. V3 and V4 in FIG. 1).

Similarly, the small PrOx air flow is regulated via its control valve (V2), and not via regulation of the compressor. Because the PrOx flow is small, specifying the response time is not required, because PrOx flow will not perturb system pressure enough to cause oscillations or other instability. However, it is convenient to have a slower response time R2 in the PrOx controller. A key aspect of the three flows illustrated is that they do not need to be implemented as coupled flows. Because of the decoupling provided by the difference in time constants, no coupling is required in the computation.

In practice, the POX air is regulated rapidly compared to the other air flows. The slower variations in the flows to the TGC (and to the fuel cell if on the same compressor) function as a slowly varying background to the POX controller. The POX controller rapidly corrects the compressor flow to maintain the POX flow rate, and thus the overall air pressure is quasi-constant even while the TGC flow is being adjusted. Because there is only one signal to the compressor, the influence of the various valve settings on the manifold pressure does not need to be computed. This greatly simplifies the creation of a control algorithm for the system, saving expense and increasing reliability. As a further benefit, it is much easier to adjust settings of individual airflows in response to overall system state, since there is still only one input to each control element. An additional benefit is that most or all of the control loops can use sensors other than air flow sensors. Only the POX air flow rate is a likely candidate for use of an air flow sensor in its regulation. Minimization of use of air flow sensors is important for cost reduction, because at low pressure drops, as often encountered in these systems, the required sensors are relatively expensive compared to monitoring temperature, or fuel injection rate.

This system has been described in terms of a POX reformer, which includes the catalytic ATR (autothermal reforming) variant. The system is also applicable to a “pure steam reformer” system. In such a system, a separate air supply and fuel supply are fed to a burner that is in thermal communication with a catalytic reforming zone, and only fuel and steam enter the actual reforming zone. The control considerations are essentially identical, with rapid control of the burner air required (similar to the control of the POX described above), and slower response time control of the fuel cell air, the PrOx air, and TGC air if separately supplied.

Likewise, the topology is illustrated here by having three or more separate inlets drawing from a common manifold. However, one or more of the PrOx, fuel cell, or TGC inlets could depend from the airflow being directed to the POX, achieving the same effect in terms of control simplification.

Fuel and water flows are typically less branched, but similar methods can be used to decouple branches of these flows as well, when required to prevent instability. For example, in a fuel processor, fuel is sometimes supplied both to the reforming zone and to an auxiliary burner, and the latter flow is influenced by the amount of hydrogen returning from the fuel cell. The burner flow is in this case typically smaller, and also typically less critical, and it can be decoupled from the main flow by use of a slower control loop, thereby decoupling the flows and making it unnecessary to consider the burner flow when adjusting the fuel pump to supply the reformer. In a steam reformer, fuel flows to both the reforming zone and to the integrated burner that heats the reformer are similar in magnitude. If they are to be supplied by a common pump or other regulator, then the flow of one—for example, the burner fuel—can be regulated with a faster time constant than the other—for example, the reformer fuel supply. This decouples the flows and prevents oscillations. (Which of these flows is the most critical will depend on details of system design.)

Water is used in the fuel processor to make steam, and the steam may in some systems be injected into the reforming section at two separate locations in similar quantities (to the reformer itself, and to the water-gas-shift unit). If the steam flows, or water flows leading to steam formation, are separately regulated (as opposed to simply being proportioned), then the regulating valves should likewise have different response times to decouple the flows. Water is also used in several other locations in the fuel processor system, including uses for cooling of reformate and of the fuel cell. When it is possible to supply these uses with a common pump, similar control considerations apply.

While this invention has been particularly shown and described with references to preferred embodiments thereof, it will be understood by those skilled in the art that various changes in form and details may be made therein without departing from the scope of the invention encompassed by the appended claims.

1. A method for simplifying the control of flow of a fluid in a fuel processor, the method comprising the steps of:
determining, from among a plurality of inputs for the fluid in the fuel processor, a first fluid input which requires the greatest precision of control of the rate of fluid flow;
regulating the rate of fluid flow at the first input based upon feedback from a sensor associated with the first fluid input, wherein such regulation occurs with a first time constant; and
regulating the rate of fluid flow at each of the remaining inputs based upon feedback from at least one sensor so that the flows satisfy at least one criterion selected from:
i) having a regulatory time constant that is at least about three times greater than the time constant of regulation of the first flow; and
ii) having a flow volume that is less than about 10% of the average flow volume of the fluid at the first input.

2. The method of claim 1 wherein the fluid comprises air, and the rate of fluid flow at the first input is regulated by controlling a compressor coupled to the first input.

3. The method of claim 2 wherein the first input flow comprises air for providing heat for a fuel reforming reaction.

4. The method of claim 2 wherein the first input flow comprises air for a combustor or burner that supplies the heat required to reform fuel in a fuel reformer selected from a partial oxidation reformer (POX), an autothermal reformer (ATR), and a “pure” steam reformer.

5. The method of claim 1 where the fluid comprises a gaseous or liquid fuel, and the input is supplied by one of a fuel compressor and a fuel pump.

6. The method of claim 1 wherein the fluid comprises liquid or gaseous water.

7. The method of claim 1 wherein the regulatory time constant for the remaining inputs is at least about five times greater that the time constant of the first input.

8. The method of claim 1 wherein the regulatory time constant for the remaining inputs is at least about ten times greater that the time constant of the first input.

9. The method of claim 1, wherein the flows of at least one fluid can be entered into a control algorithm without requiring coupling of the flows to each other in the computations required to control the system.

10. A fuel processor comprising:
a fuel reforming unit having a fluid inlet for varying the rate of input of a fluid;
a hydrogen-cleanup unit having a fluid inlet for varying the rate of input of the fluid;
a fluid conduit for providing the fluid to a fuel cell, the fluid conduit having a fluid inlet for varying the rate of input of the fluid;
a control system which determines, from among the fluid inlets of fuel reforming unit, the hydrogen-cleanup unit, and the fluid conduit for the fuel cell, a first fluid inlet which requires the greatest precision of control of the rate of input of the fluid, the control system regulating the rate of fluid flow at the first fluid inlet based upon feedback from a sensor associated with the first fluid inlet, wherein such regulation occurs with a first time constant, the control system further regulating the rate of fluid flow at each of the remaining fluid inlets based upon feedback from at least one sensor so that the flows satisfy at least one criterion selected from: i) having a regulatory time constant that is at least about three times greater than the time constant of regulation of the first inlet; and ii) having a flow volume that is less than about 10% of the average flow volume of the fluid at the first inlet.

11. The fuel processor of claim 10, wherein the sensor associated with the first fluid inlet comprises a fluid flow rate sensor.

12. The fuel processor of claim 10 wherein the fluid is air.

13. The fuel processor of claim 12 wherein the control system varies the rate of fluid flow at the first inlet by controlling a compressor coupled to the first inlet.

14. The fuel processor of claim 13 wherein the air from the compressor is fed to a plenum, and from the plenum to a plurality of fuel processor components via at least one controllable valve.

15. The fuel processor of claim 14 wherein the first fluid inlet comprises an inlet to the fuel reforming unit.

16. The fuel processor of claim 15 wherein the rate of input of fluid to the fuel reforming unit is controlled by varying the output of the compressor.

17. The fuel processor of claim 16 wherein the rate of input of fluid to the hydrogen-cleanup unit and the fuel cell is controlled by adjusting valves associated with the hydrogen-cleanup unit and the fuel cell.

18. The fuel processor of claim 10 further comprising:
a tail gas combustor having a fluid inlet for varying the rate of input of a fluid, wherein the control system regulates the rate of fluid flow to the fuel reforming unit, the hydrogen-cleanup unit, the fuel cell, and the tail gas combustor.

19. The fuel processor of claim 10 wherein the fuel reforming unit comprises a partial oxidation reformer.

20. The fuel processor of claim 10 wherein the fuel reforming unit comprises an autothermal reformer.

21. The fuel processor of claim 10 wherein the fuel reforming unit comprises a pure steam reformer.

22. The fuel processor of claim 10 wherein the hydrogen-cleanup unit comprises at least one of a water gas shift reactor, and a preferential oxidation reactor.

23. The fuel processor of claim 10 wherein the fluid comprises water.

24. The fuel processor of claim 10 wherein the fluid comprises fuel.

25. The fuel processor of claim 10 wherein the control system varies the rate of fluid flow at the first inlet by controlling a pump coupled to the first inlet.
